(19) United States
(12) Patent Application Publication
(10) Pub. No.: US 2010/0332407 A1
(43) Pub. Date: Dec. 30, 2010

(54) SYSTEM FOR DISTRIBUTING PERISHABLE GOODS

(75) Inventors: Bruce Donaldson Grieve, Manchester (GB); Mark Waltham, Basel (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignees: SYNGENTA CROP PROTECTION, INC., Greensboro, NC (US); SYNGENTA LIMITED, Guildford, Surrey (GB)

(21) Appl. No.: 12/522,600

(22) PCT Filed: Jan. 16, 2008
(86) PCT No.: PCT/GB08/00130

§ 371 Date: Mar. 24, 2010

(30) Foreign Application Priority Data
Jan. 19, 2007 (GB) 0701074.7

(51) Int. Cl. G06Q 10/00

(52) U.S. Cl. 705/332

(57) ABSTRACT

The present invention relates to a system for distributing perishable goods. In particular, it relates to a system for monitoring stress suffered by perishable goods during transport. In particular, it relates to a system and method for distributing cut flowers and/or vegetables.

The present invention relates to a system for distributing perishable goods. In particular, it relates to a system for monitoring stress suffered by perishable goods during transport, and use of the information collected to predict the shelf life of the goods. In particular, it relates to a system and method for distributing cut flowers and/or vegetables.

Numerous systems have been developed for tracing products, and tracking their progress through the supply chain. For example, International Patent Application publication number WO03/060752 relates to a supply chain management method. In particular, it discloses a method for real-time management of inventory. Also, International Patent Application publication number WO05/008554 relates to package tracking and logistics. In particular, it discloses a system for allowing the status of a product to be tracked as it progresses through the supply chain. US patent application US2006/111845 relates to a method of tracing agricultural inventories through a supply chain by associating various processing events to a unique identifier and storing the information in a data warehouse. Many of these systems make use of Radio Frequency identification (RFID) tags.

Environmental conditions endured by perishable goods during storage and transport have a significant impact on the ultimate shelf-life of the goods. It is known that sensing of environmental factors such as temperature can be used to monitor the shelf-life of such goods. For example, International Patent Application publication number WO2005/106813 relates to a shelf-life monitoring sensor transponder system for perishable products. The application generally describes the use of the system for monitoring the integrity of perishable products over multiple segments of a product supply chain. US patent application US2004/181363 relates to a device for indicating the residual life of industrial products. The device senses one or more environmental variables correlated with the preservation of the product, and uses the data to evaluate the residual life of the product.

Maintaining good shelf life is a particular problem in the cut flower industry. The optimum storage and transport temperature for cut flowers is between 2 and 5° C. It is known that stress derived from, for example, undesirable environmental conditions, correlates with reduced shelf-life. The effects of a poor cool chain on flowers include high arrival temperatures, progressed opening of buds and uneven ripeness, increased Botrytis infection, shortened vase life, destroyed and bent stems, and shrivelled or damaged leaves. The effect of storage temperature on the quality of cut flowers is discussed in Celikel et al. (HortScience 37(1), 148-150), and in Cevallos et al. (Acta Hort, 517).

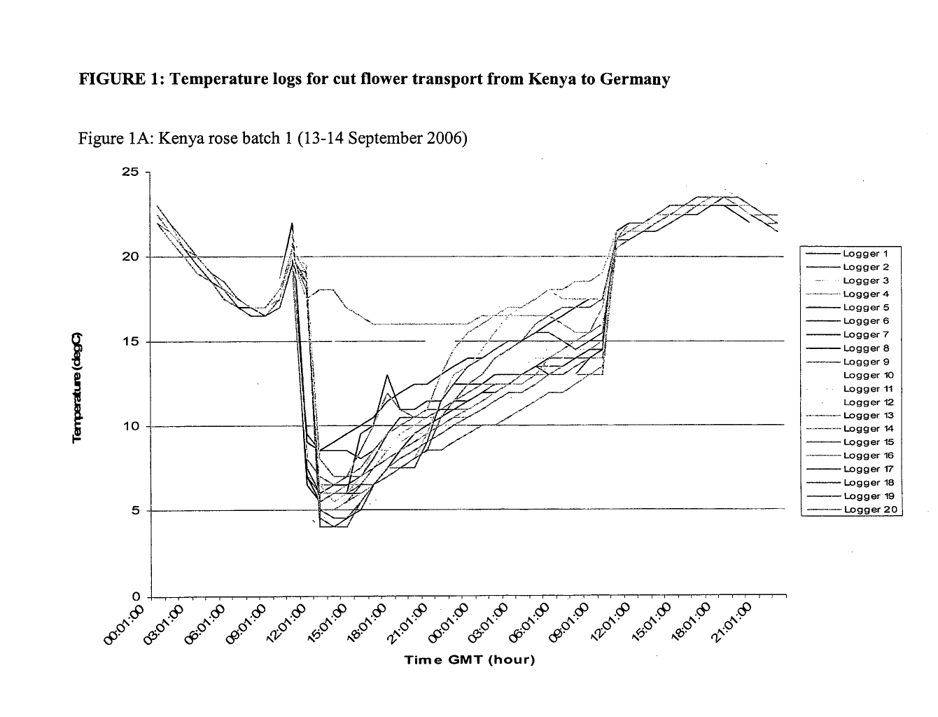

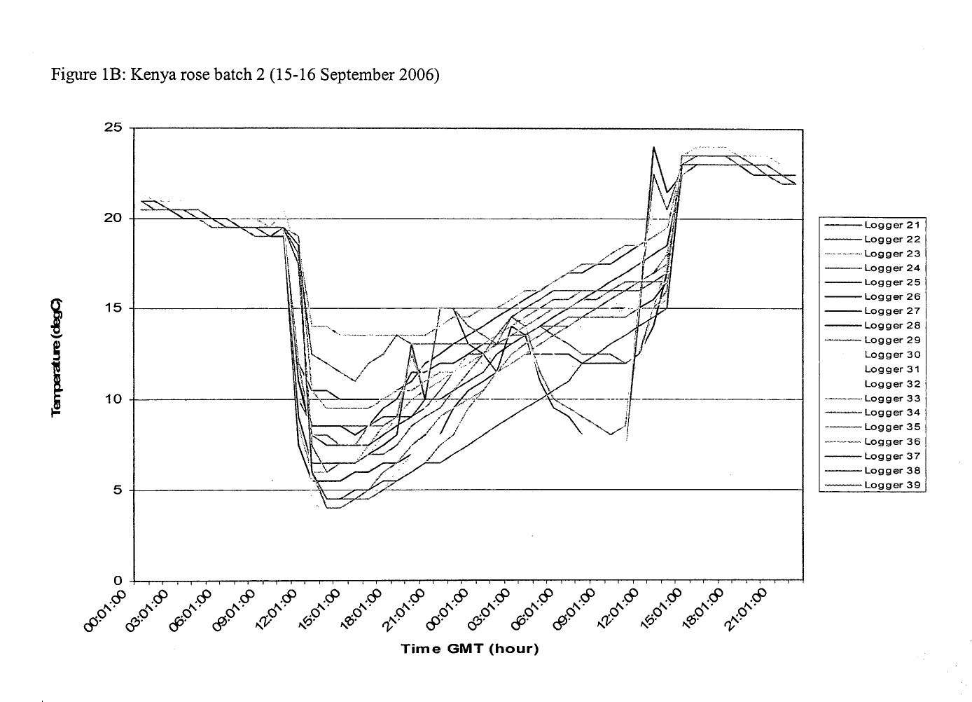

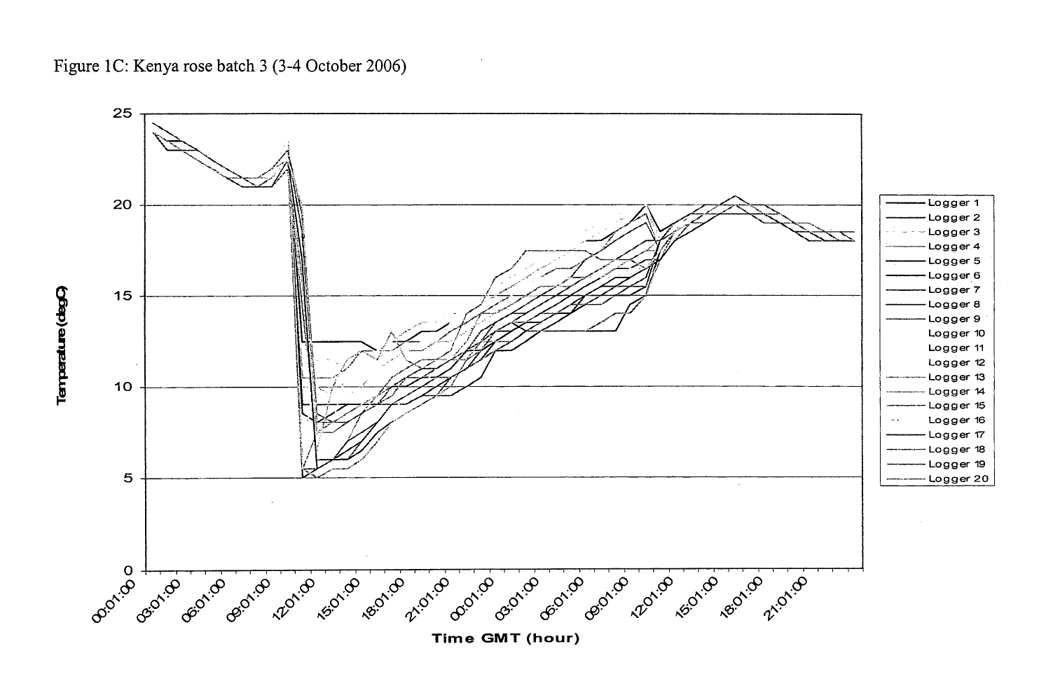

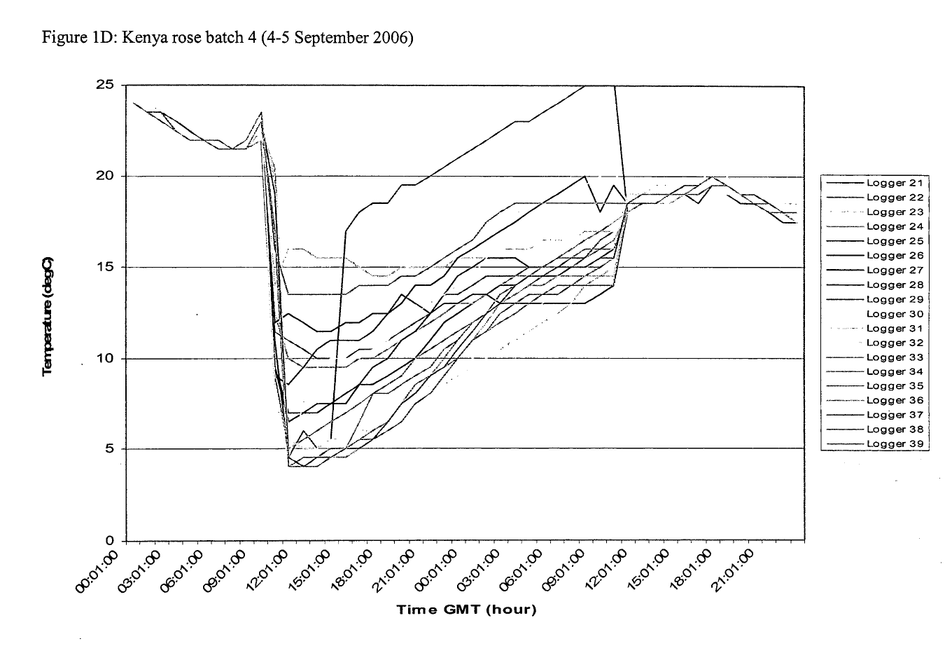

FIG. 1 (A to D) displays temperature logs taken during the transport of 4 batches of roses from Kenya to an importer warehouse in Germany. Each batch consisted of 19 or 20 boxes of cut flowers, and temperature readings were taken at regular intervals over the 2 day transport period. The data shows that, although the flowers were cooled to 5° C. before leaving the grower's premises, the temperature in the microenvironment around the flowers increased considerably during transport, and the flowers arrived at the warehouse at a temperature of between 17 to 24° C. The data shows that the variation between shipments in the temperature of the flowers upon arrival at their destination, can be very significant. Additionally, even within a single shipment of flowers, a wide variation is observed in the temperature-induced stress that each batch of flowers is exposed to as they are transported. This problem is widely recognised within the cut flower industry.

This problem could be overcome through the use of temperature controlled lorries in the supply chain. However, this solution is not practical, especially in key flower producing countries such as Kenya and Columbia, since the cost of installing and maintaining refrigeration units to establish a reliable cool chain infrastructure is prohibitive.

Therefore, it is desirable to monitor the environmental conditions that each batch of flowers is subjected to, so that flowers that have been subjected to less stress and will therefore have a longer shelf life, can be readily identified. It is also desirable to monitor the onset of disease that can reduce shelf life and accelerate senescence of perishable goods.

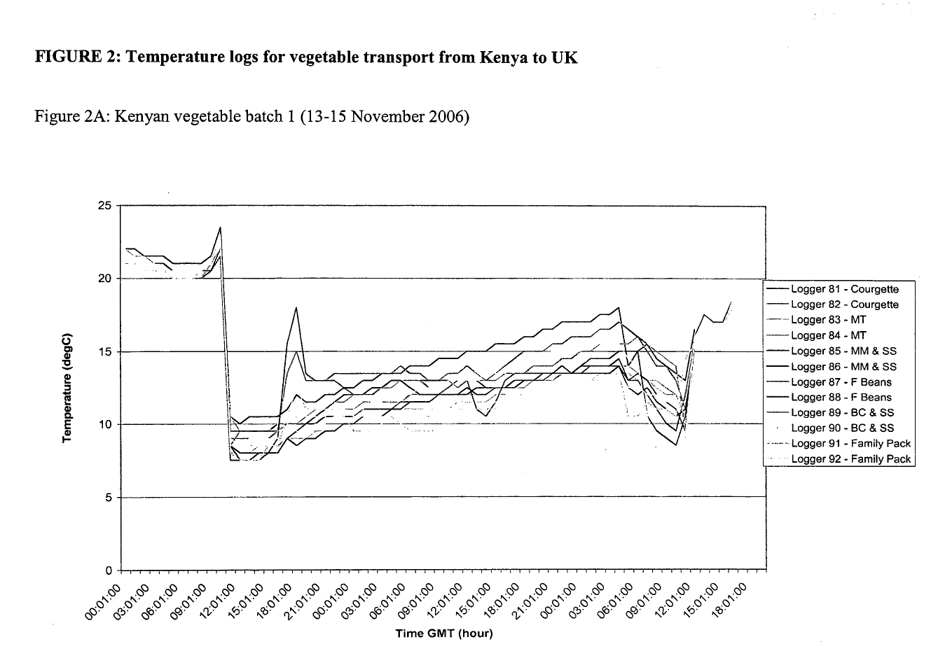

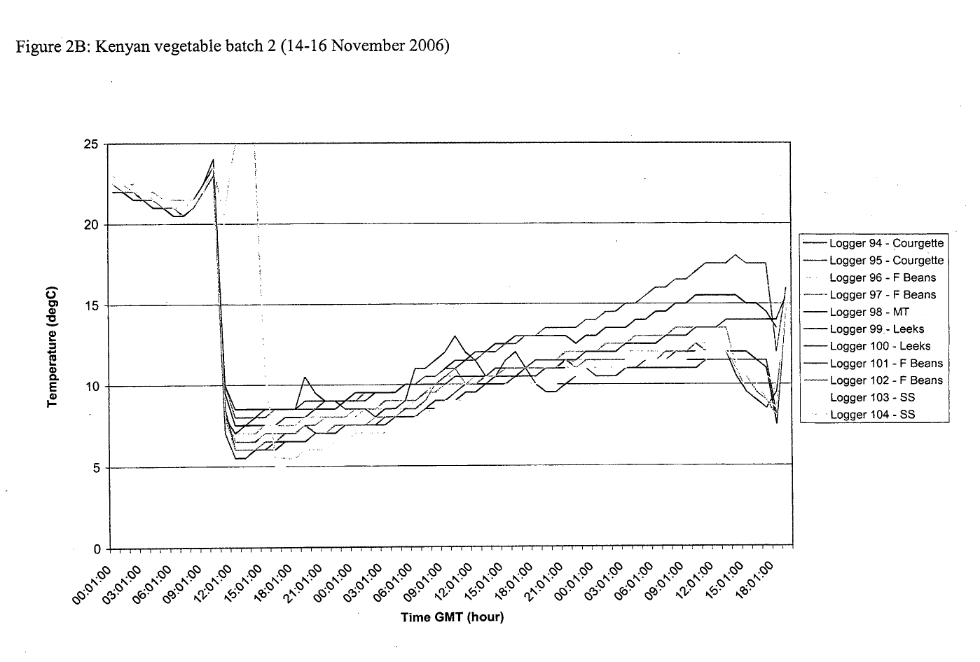

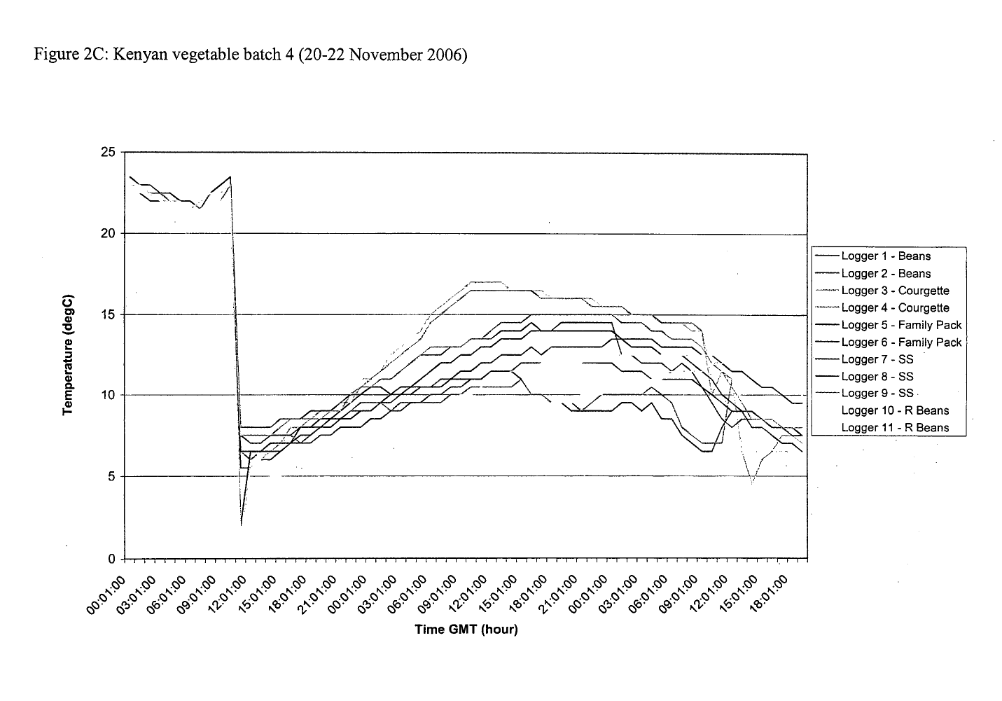

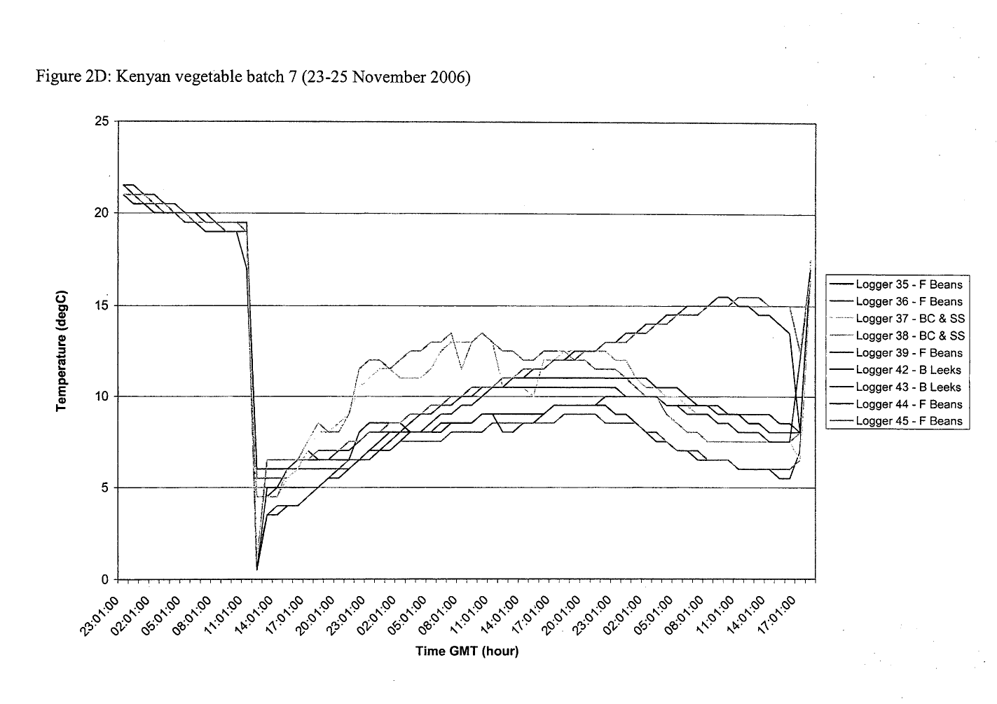

Similarly, the environmental conditions to which vegetables are exposed during transport and storage has a significant impact on their shelf life. As with cut flowers, the optimum transport temperature for vegetables is between 2 and 5° C. FIG. 2 (A to D) displays temperature logs taken during the transport of 4 batches of vegetables from Kenya to the UK. Each batch comprised several vegetable types, including courgettes, beans and leeks. The data shows that the temperature in the microenvironment around the vegetables increased considerably during transport, and that the vegetables arrived at the warehouse at elevated temperatures, sometimes above 15° C. The data also shows that there is significant variation between shipments in the temperature of the vegetables upon arrival at their destination.

As with cut flowers, it is desirable to monitor the environmental conditions that each batch of vegetables is subjected to, and the onset of disease, so that vegetables that have been subjected to less stress and will therefore have a longer shelf life, can be readily identified.

Dataloggers that capture environmental information such as temperature at regular intervals during the supply chain are known. Further, it is known that temperature-induced stress can be correlated with shelf life. However, existing datalogger systems rely on download and subsequent analysis of the data captured during transport, upon arrival at the destination.

The present invention relates to a shelf-life forecasting system that predicts the expected shelf-life of perishable goods as they are being transported. Optionally, the system also updates the predicted shelf-life at regular intervals to take account of changes in environmental conditions that the goods are exposed to as they are transported, and indications of the onset of disease. Further, the system relays the shelf-life forecast forwards through the supply chain in real time.

According to the present invention, there is provided a system for distributing perishable goods, comprising at least one sensor that measures the environmental conditions and optionally detects compounds indicative of pathogen infection adjacent to the goods, an RFID tag linked to each sensor or group of sensors that transmits the data collected by the sensor or sensors to an RF reader, a means for transmitting the data from the RF reader to a downstream point in the supply chain, and a computer program that predicts the shelf life of the goods using the environmental condition and pathogen detection data, and uses the predicted shelf life to route the goods to a particular distribution channel.

The system can be applied to the distribution of any perishable goods, including but not limited to meat, fruit, vegetables, wine, plants, cut flowers, medicines and drugs. In a preferred embodiment, the system is used for the distribution of cut flowers. In another preferred embodiment, the system is used for the distribution of vegetables.

In one embodiment of the invention the sensor measures the environmental conditions and/or compounds indicative of pathogen infection adjacent to the goods at regular time intervals. For example, the sensor may take a reading at least 1, 2, 3, 6, 12 or 30 times per hour, or 1, 2, 3, 6, 12, 30 or 60 times per minute. There is no upper limit to the frequency of data collection by the sensor. Suitably, the sensor takes a reading at least 6 times per hour, equating to once every 10 minutes.

The sensor is located in close proximity to the goods, for example, it is attached to or placed within each individual item, box, crate, pallet or shipment. Where it is desirable to measure several environmental conditions or both environmental conditions and compounds indicative of pathogen infection, more than one sensor may be used. The invention includes sensors that measure any environmental conditions that may have an impact on, or would otherwise be useful in determining, the shelf life of the perishable goods being distributed.

Preferably, each RFID tag is assigned a unique identifier that is transmitted to the RF reader together with environmental data that is collected by the sensor or sensors. Therefore, the data collected from any one RFID-tag over a period of time can be analysed to check what environmental conditions that particular RFID-tag, and the actual goods with which it is associated, has been exposed to. The unique identifier may be designated to one tag or may be reassigned across a series of tags which are attached to the batch or item of produce as it progresses along the distribution chain. The sensors utilised may include, for example, temperature, humidity, ethylene, acceleration, ambient light, oxygen, nutrient availability, fungal spores or any other ambient conditions which may influence the longevity of perishable produce.

The RF reader collects data from the RFID tags by either passive or active means. For example, the RF reader may send a suitable signal to trigger the RFID tag or tags to transmit data. Alternatively, the RFID tags may actively transmit data continuously, or at regular intervals. The time intervals at which environmental data is transmitted and collected can be specified by the user when the system is set up. Optionally, the user can also change the time intervals for data collection at any other time. Data must be collected frequently enough to ensure that changes in environmental conditions are detected, and that the shelf-life of the goods can be predicted as accurately as possible. For example, data can be collected from each RFID-tag between one and sixty times per every hour. In one aspect of the invention, data is collected between 2 and 30 times every hour. Preferably, data is collected from each RFID-tag between 6 and 12 times every hour. More preferably, data is collected from each RFID-tag 6, 7, 8, 9, 10, 11 or 12 times every hour. This equates to collecting environmental data once every 5 to 10 minutes. There is no upper limit to the frequency of data collection, but for an active RFID-sensor tag this will probably be limited by the capacity of the power source. This power source may be a disposable element, a rechargeable unit or a combination of the two. Where a rechargeable device is utilised power scavenging techniques may be incorporated to re-energise the RFID-tag including, but not exclusively, power from photovoltaic, kinetic, electromagnetic transmission, or temperature differential sources. For a passive RFID-sensor tag a non-electrical method of storing the chronological records may be used, for example through a permanent, time-dependant, chemical change in an array of sensor elements.

Depending on the number of RFID-tags, and their proximity to the RF reader, it may be appropriate to include more than one RF reader. Where a separate tag is attached to or associated with each individual item, the number of RFID-tags may exceed the capacity of a singe RF reader, and so several RF readers may be required. Alternatively, a single reader can be used, and RFID tags can be set up to queue their data streams if the reader does not have adequate bandwidth. In a further aspect of the invention, data may be retrieved from tags that are not in direct communication with the receiving antenna by data-hopping from tag to tag to reader. Techniques such as those described above are well known in the art.

Any suitable means may be employed for transmitting the data from the RF reader to a downstream point in the supply chain. The data may be transmitted at any desirable frequency, for example 1, 2, 3, 6, 12, 30 or 60 times per hour, or more often. Such techniques include a direct hard-wired connection, a local area wireless network to a direct hard-wired hub or a wide area wireless network, for example a cellular phone system. The person skilled in the art is familiar with other technologies that could be employed in this respect. The RF data is suitably transmitted to a computer that processes the data via an algorithm to calculate the predicted shelf life of the goods. The shelf-life prediction is then transmitted downstream in the supply chain.

In a further embodiment of the invention the sensor measures one or more environmental conditions selected from the group consisting of temperature, relative humidity, pressure, vibration and ethylene levels. Any suitable environmental conditions that impact or, or are indicative of shelf life, can be monitored. In cut flowers for example, factors that cause stress, and therefore may result in reduced shelf life, include, but are not limited to, temperature, relative humidity, light and ethylene levels. Flower vase life and vegetable shelf life can be predicted based on the amount of stress and/or temperature profile recorded during transport.

Sensors may also be employed to detect pathogen-induced stress of perishable goods. Fungal pathogens, such as Botrytis, Aspergillus and Penicillium, directly reduce the quality of perishable goods, as well as accelerating their senescence rate.

Pre-infection detection may involve monitoring raw analytes from the perishable goods being transported (for example including liquid analytes such as sugars and phenolics, and vapour analytes such as ethanol and acetaldehyde), in addition to environmental conditions such as temperature, humidity and physical damage, to indicate whether the goods are susceptible to pathogen infection. The analytes can be detected via various non-invasive techniques that are known to those skilled in the art, for example vibrational spectroscopy (IR), fluorescence spectroscopy (UV), refractive index, ion-selected field effect transistors (ISFETs), and molecularly imprinted polymers (MIPs).

Detection of pathogen infection that has already occurred may be based on molecular binding techniques to detect the release of signalling molecules (such as cAMP, calcium and inositol triphosphate), hydroxyproline rich glycoproteins, and phenolics. Also, increased lignification of cell walls that can occur as a result of pathogen infection, may be detected by measuring a change in backscattered light.

In a further embodiment of the invention, the sensor detects one or more compounds that may be indicative of pathogen infection, selected from the group consisting of ethylene, sugars, phenolics, ethanol, acetaldehyde, hydroxyproline rich glycoproteins, cAMP, calcium and inositol triphosphate. The sensor may not only detect the presence of any of said compounds, but optionally also measure their amount, so that any changes in the amount of the compound(s) detected can be monitored over time.

In another embodiment of the invention the predicted shelf life is re-calculated regularly to reflect any changes measured in the environmental conditions. Suitably, the predicted shelf-life is re-calculated each time new data is received. Suitably, the predicted shelf-life is re-calculated at least once every 10 minutes. The computer program performs shelf-life calculations by inputting the environmental data to an algorithm. Suitable algorithms are based on the relationship between environmental conditions such as temperature, and time. These are known to the person skilled in the art, and may be adapted so that they are specific for individual goods, such as particular species of cut flowers or vegetable. The computer model preferably includes information on the cultivar variety, and optionally, the inputs that have been made during growing such as chemical applications, fertiliser feed, moisture and light. Agronomy data is useful to enhance the fidelity of the computer model. An exemplar of such a computer model has been reported in the public domain for rose species Rosa canina and Rosa indica, where temperature information versus time has been related to prediction of the plant senescence and disease susceptibility.

In order to develop a suitable algorithm that can be used to detect pathogen infection, it is necessary to first determine what detectable changes occur upon infection. Such changes will likely be specific for particular types of perishable goods, for example in the case of cut flowers, for particular flower species, and can be readily determined by the person skilled in the art.

One method that can be employed in real-time prediction of the shelf-life of perishable goods going through the cold supply chain, is the multivariate statistical process control (MSPC) approach, a technique that is currently used for online prediction of end-of-batch product quality based on quality supervision in chemical batch processes. Another method is the kinetic modelling (KM) approach, that considers the senescence of perishable produce as a decaying process in the quality content which is modelled kinetically.

The system of the invention provides advantages to all persons in the supply chain. This is exemplified below with respect to the cut flower supply chain, but is equally applicable to the supply chain of other perishable goods, including vegetables.

The grower benefits because the flowers he sells at auction can be attributed a shelf-life prediction or guarantee. The shelf life guarantee directly impacts on the auction price that the grower will obtain for his flowers, since high quality flowers attract a significant premium. Conversely, flowers of lower quality can be sold very cheaply, thus minimising the cost to the grower of disposing of unsold goods due to poor quality. Further, over time the grower will accrue a good reputation for being able to sort his flowers according to predicted shelf-life, and this has a positive impact on future business for the grower.

The importer benefits because he is able to purchase flowers at auction that he knows have not been subjected to adverse environmental conditions, and so will have a long shelf-life. In this way, the importer supplies retailers with reliable, high quality products, and also minimises the cost of importing inferior quality goods that cannot subsequently be sold.

The retailer benefits because he sources high quality goods, and is able to sell these to the consumer with a shelf-life promise or guarantee. Further, when the retailer purchases flowers with a long shelf-life, he has longer to sell them before spoilage occurs, therefore minimising loss of revenue. Also, as the retailer accrues a reputation for supplying high quality flowers, he is able to sell these for a premium price.

Finally, the consumer benefits because he knows that he is buying high quality flowers that will have a long shelf-life.

The system of the present invention provides further advantages at several points in the supply chain. If a box of goods is stressed while it is in transit, the shelf-life forecast that is relayed downstream in the supply chain will identify this, and appropriate action can be taken immediately. For example, corrective crash re-chilling may be applied to the affected goods or boxes to partly recover the quality. Alternatively, if pathogen infection is detected, a remedial chemical treatment can be applied to kill the causal pathogen and prevent spread of the infection, therefore preserving the quality and shelf life of the goods. Suitable remedial chemical treatments are well known to those skilled in the art; for example if Botrytis infection is detected on cut roses, a spray or fog application of the fungicide Switch® may be made.

Alternatively, the stressed or infected goods can be discarded and/or replaced by higher quality goods to eliminate inferior goods from the entire shipment, and ensure that money is not wasted transporting poor quality goods. Alternatively, the goods can be shipped to a particular geographical location or via a particular mode of transport (such as road, rail, sea, air), to ensure that only goods having a longer predicted shelf life are subjected to lengthy shipping times. Alternatively, lower quality goods can be sold at a very low price, and/or directed away from retailers that demand only high quality goods having a long shelf-life.

In one embodiment the system may provide a supply chain alert for poor quality goods. If importer or retailer knows in advance that the goods en route to him have been stressed or become infected during transport, he can take action immediately, rather than discovering that the quality of the goods has been compromised only when he downloads environmental data collected during transport upon arrival. For example, he may place a new order to fill the predicted shortfall of high quality goods, may source the shortfall from another supplier, or in the case of an importer may warn the retailer that a shortfall of high quality goods is likely to occur.

A further advantage of the present invention is the ability to target batches of goods to particular locations. For example, in the case of cut flowers, high quality flowers may be directed to premium florists, whereas lower quality flowers may be directed to low quality supermarkets. Flowers that have been subjected to high levels of stress can be disposed of at the earliest opportunity, thus minimising the cost of shipping inferior products that cannot be sold, and maintaining a good reputation for the grower, importer and retailer.

The system also ensures visibility of the quality of the goods to all parties in the supply chain. Accordingly, goods of a known quality can be reliably and consistently sold, at a price that is dictated at least in part by the quality, at all stages of the supply chain.

According to the present invention, there is provided a method for distributing perishable goods, comprising measuring environmental conditions that the goods are exposed to over time, to generate environmental condition data; optionally detecting the presence of compounds that are indicative of pathogen infection; using the environmental condition and pathogen detection data to calculate the predicted shelf life of the goods; and sending the predicted shelf life data to a downstream point in the supply chain so that the goods can be routed to a particular distribution channel according to the predicted shelf life. In a preferred embodiment, the goods are cut flowers and/or vegetables.

In one embodiment of the invention the environmental conditions and presence of compounds indicative of pathogen infection are measured by one or more sensors that are adjacent to the goods. Sensors may be attached to the goods, or one or more batches, boxes, or crates of goods, and measure any suitable environmental condition or detect any suitable compound as described above. In another embodiment of the invention the environmental conditions and presence of compounds indicative of pathogen infection are measured regularly over time as described above. In a further embodiment of the invention, the predicted shelf life is re-calculated regularly to reflect any changes measured in the environmental conditions, or presence of compounds indicative of pathogen infection, as described above.

According to the present invention, there is provided the use of a system as defined above to determine the distribution of perishable goods in the supply chain. In a preferred embodiment, the goods are cut flowers and/or vegetables.

According to the present invention, there is provided the use of a system as defined above to determine the retail price of perishable goods based on their predicted shelf life. In a preferred embodiment, the goods are cut flowers and/or vegetables.

According to the present invention, there is provided a method for providing a shelf life assurance service for perishable goods to the customer, comprising distributing the goods using the system and/or the method defined above. In a preferred embodiment, the goods are cut flowers and/or vegetables.

1. A system for distributing perishable goods, comprising
a) at least one sensor that measures the environmental conditions and optionally detects compounds indicative of pathogen infection adjacent to the goods,
b) an RFID tag linked to each sensor or group of sensors, that transmits the data collected by the sensor or sensors to an RF reader,
c) a means for transmitting the data from the RF reader to a downstream point in the supply chain, and
d) a computer program that predicts the shelf life of the goods using the environmental condition and pathogen detection data, and uses the predicted shelf life to route the goods to a particular distribution channel.

2. A system according to claim 1, wherein the sensor measures the environmental conditions or compounds indicative of pathogen infection adjacent to the goods at regular time intervals.

3. A system according to claim 1, wherein the sensor measures one or more environmental conditions selected from the group consisting of temperature, relative humidity, pressure and vibration.

4. A system according to claim 1, where the sensor detects one or more compounds indicative of pathogen infection selected from the group consisting of ethylene, sugars, phenolics, ethanol, acetaldehyde, hydroxyproline rich glycoproteins, cAMP, calcium and inositol triphosphate.

5. A system according to claim 1, wherein the predicted shelf life is re-calculated regularly to reflect any changes measured in the environmental conditions.

6. A system according to claim 1, wherein the goods are cut flowers or vegetables.

7. A method for distributing perishable goods, comprising
a) measuring environmental conditions that the goods are exposed to over time, to generate environmental condition data,
b) optionally detecting compounds that are indicative of pathogen infection,
c) using the environmental condition and pathogen detection data to calculate the predicted shelf life of the goods, and
d) sending the predicted shelf life data to a downstream point in the supply chain so that the goods can be routed to a particular distribution channel according to the predicted shelf life.

8. A method according to claim 7, wherein the environmental conditions and detection of compounds are measured by one or more sensors that are adjacent to the goods.

9. A method according to claim 7, wherein the environmental conditions and detection of compounds are measured regularly over time.

10. A method according to claim 9, wherein the predicted shelf life is re-calculated regularly to reflect any changes measured in the environmental conditions or compounds indicative of pathogen infection.

11. A method according to claim 7, wherein the goods are cut flowers or vegetables.

12. (canceled)

13. (canceled)

14. A method for providing a shelf life assurance service for perishable goods to the customer, comprising distributing the goods using the system as defined in claim 1.
